(19) United States
(12) Patent Application Publication
(10) Pub. No.: US 2008/0124536 A1
(43) Pub. Date: May 29, 2008

(54) Water-Resistant Image-Receiving Sheet For Electrophography

(75) Inventors: Kiyoshi Iwamoto, Fujieda-shi (JP); Nobuhiro Kubota, Shizuoka-shi (JP); Senichi Yoshizawa, Yaizu-shi (JP)

Correspondence Address: WOOD, HERRON & EVANS, LLP, 2700 CAREW TOWER, 441 VINE STREET, CINCINNATI, OH, 45202, US

(73) Assignee: TOMOEGAWA CO., LTD., Tokyo (JP)

(21) Appl. No.: 11/720,385

(22) PCT Filed: Nov. 28, 2005
(86) PCT No.: PCT/JP2005/021780

§ 371 Date: May 29, 2007

(30) Foreign Application Priority Data
Nov. 30, 2004 (JP) 2004-345736
Sep. 2, 2005 (JP) 2005-254228

(51) Int. Cl. B32B 5/16; B32B 23/08; B32B 27/10; B32B 29/00

(52) U.S. Cl. 428/327; 428/537.5; 428/512

(57) ABSTRACT

The present invention provides an image-receiving sheet for electrophotography wherein the water-resistant image-receiving sheet for electrophotography, comprises a base paper,

one or two plastic films adhered to the one or both surfaces of the base paper, and a toner-receiving layer formed on at least a surface of the plastic film, wherein a main component of the toner-receiving layer is a resin with a transition temperature of 0l to 80° C., and the surface resistance is 1×10⁷ to 1×10¹¹ Ω/□.

### TECHNICAL FIELD

The present invention relates to an image-receiving sheet for electrophotography. More particularly, the present invention relates to a water-resistant image-receiving sheet for electrophotography which enables consecutive printing without causing sticking or blistering, and is excellent in toner-fixing property and transfer property for color copiers.

### BACKGROUND ART

With the introduction of color and high performance to electrophotography printing machines and printers, besides general documents, printed matter is being used in various ways including posters, cards, labels, and documents which include color photographs. However, since printing is done on paper, water-resistance and anti-fouling properties are inferior, and when used for applications such as restaurant menus which are easily soiled from water or oil, product signs at perishable foods stores, or posters displayed outdoors, it was necessary to perform post treatment such as laminating with plastic film after printing.

By electrophotographic printing on paper which has film applied on both surfaces beforehand, problems with weakening of the toner-fixing properties such as abrasion-resistance and durability due to the fixed toner becoming detached when the image is rubbed, problems of not being able to attain high quality color images because of difficulty in attaining sufficient image darkness and reduction in color saturation due to weakening of toner transfer property, and problems regarding paper conveying and poor external appearance due to blisters forming between the paper and film by heat from the heat fixing during the printing, arise.

However, for example, in Patent document 1, an image-receiving sheet for electrophotography is proposed in which a particular polypropylene resin layer is formed on both surfaces of the base paper, and a toner image-receiving layer is formed over the polypropylene resin layer. Further, in Patent document 2, an image-receiving sheet for electrophotography is proposed in which both surfaces of the base paper are coated with resin that has film formation ability, and the volume specific resistance of the base paper and the average roughness of the central area of the resin-coated surface are specified. However, the type of electrophotographic printing paper proposed in the patent references have a problem of toner transfer (sticking) where toner from the printed surface adheres to the back surface of printed matter when printed matter accumulates in a stack during consecutive printing.

### Patent document 1:

Japanese Unexamined Patent Application, First Publication No. 2002-351121

### Patent document 2:

Japanese Unexamined Patent Application, First Publication No. 2005-17843

### DISCLOSURE OF INVENTION

Therefore, the present invention has an objective of improving the above-described problems which exist in background art. More specifically, the objective of the present invention is to provide a water-resistant image-receiving sheet for electrophotography which has excellent toner-fixing and transfer properties, can provide beautiful images, and in which blisters do not form during heat fixing. The other objective of the present invention is to provide a water-resistant image-receiving sheet for electrophotography that enables continuous printing without causing sticking.

The water-resistant image-receiving sheet for electrophotography of the present invention includes a base paper, one or two plastic films adhered onto one or both surfaces of the base paper, and a toner-receiving layer formed over at least one of the plastic films, wherein the first aspect thereof is that the main component of the toner-receiving layer is resin with a glass transition temperature of 0 to 80° C. and with a surface resistance of 1×10⁷ to 1×10¹¹ Ω/□. Further, the second aspect thereof is that the toner-receiving layer includes resin with a glass transition temperature of 0 to 80° C., a low-resistance treatment agent, and organic polymer fine particles.

With the present invention, the plastic film is adhered onto the base paper through an adhesive layer. For the base paper, moisture of not more than 5% is preferable, and it is preferable that the base paper be impregnated with resin. Further, it is preferable that the plastic film be a polyethylene terephthalate film. Further, it is preferable that the organic polymer fine particle be an acrylic resin fine particle with an average diameter of 0.5 to 15 μm. Furthermore, it is preferable that the image-receiving sheet for electrophotography of the present invention has an impregnation degree of water from the edge surface of not more than 4 mm.

The water-resistant image-receiving sheet for electrophotography of the present invention is excellent in toner fixing property and transfer property, can provide beautiful high quality images which have excellent durability, and blisters do not form during heat fixing. Further, if the toner-receiving layer includes organic fine particles, even during continuous printing, the printed matter does not stick together.

### BRIEF DESCRIPTION OF THE DRAWINGS

FIG. 1 is a schematic cross-section showing one example of the water-resistant image-receiving sheet for electrophotograpy of the present invention.

FIG. 2 is a schematic cross-section showing another example of the water-resistant image-receiving sheet for electrophotograpy of the present invention.

FIG. 3 is a schematic cross-section showing another example of the water-resistant image-receiving sheet for electrophotograpy of the present invention.

FIG. 4 is a schematic cross-section showing another example of the water-resistant image-receiving sheet for electrophotograpy of the present invention.

### DESCRIPTION OF THE NUMERALS

1 . . . Base paper; 2, 2a, 2b . . . Adhesive layer; 3, 3a, 3b . . . Plastic film; 4, 4a, 4b . . . Toner-receiving layer; 5 . . . Organic polymer fine particle.

### BEST MODE FOR CARRYING OUT THE INVENTION

First, the image-receiving sheet for electrophotography of the present invention is described referring to the drawings.

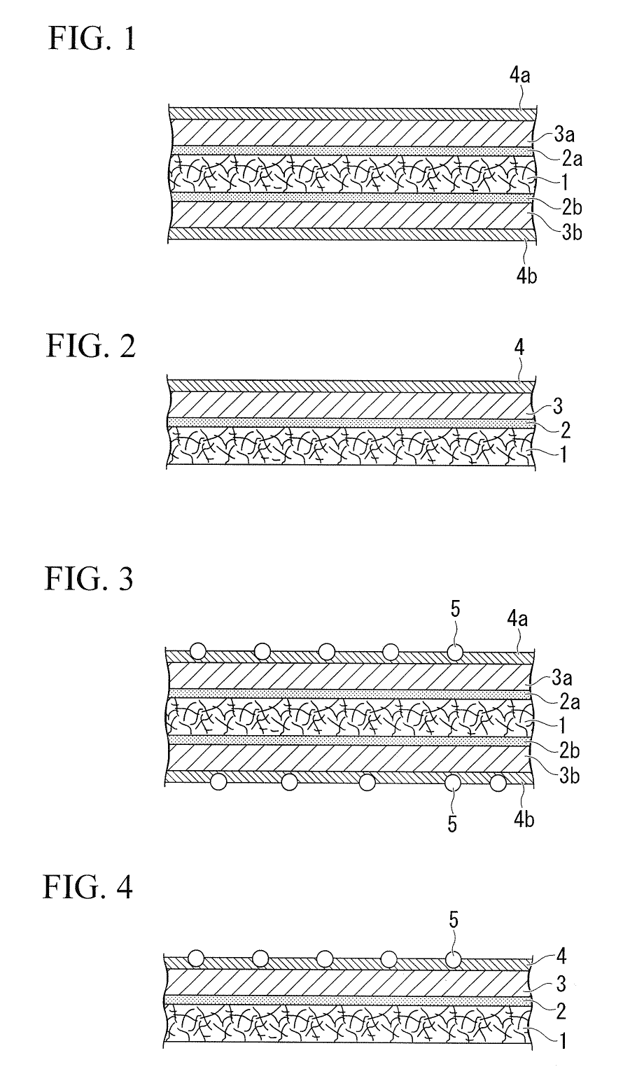

FIG. 1 and FIG. 2 are schematic cross-sections showing the image-receiving sheets for electrophotograpy of the first aspect of the present invention. In FIG. 1, plastic films 3a and 3b are adhered onto both surfaces of a water-resistant base paper 1 through adhesive layers 2a and 2b, and toner-receiving layers 4a and 4b are formed over the plastic films. Further, in FIG. 2, a plastic film 3 is adhered onto one surface of the base paper 1 through an adhesive layer 2, and a toner-receiving layer 4 is formed over the plastic film 3.

FIG. 3 and FIG. 4 are schematic cross-sections showing water-resistant image-receiving sheets for electrophotograpy of the second aspect of the present invention. In FIG. 3, the plastic films 3a and 3b are adhered onto both surfaces of the water-resistant base paper 1 through the adhesive layers 2a and 2b, and the toner-receiving layers 4a and 4b including an organic polymer fine particle 5 are formed over the plastic films. Further, in FIG. 4, the plastic film 3 is adhered onto one surface of the base paper 1 through the adhesive layer 2, and the toner-receiving layer 4 including the organic polymer fine particle 5 is formed over the plastic film.

The thickness of the image-receiving sheet for electrophotography of the present invention is preferably within a range of 70 to 400 μm, more preferably within a range of 100 to 300 μm. For cards and photographs, a range of 150 to 300 μm is preferable. If the thickness is less than 70 μm, since the strength is not sufficient, it is unsuitable for cards and photographs, and might cause poor conveying problems on electrophotographic printing machines and printers. If the thickness exceeds 400 μm, poor conveying problems on the electrophotographic printing machines and printers might be caused due to the strength being excessive.

In the image-receiving sheet for electrophotography of the present invention, the impregnation degree of the water from the edge surface is preferably not more than 4 mm when measured by the water-resistance measurement described later. If the impregnation degree of the water from the edge surface exceeds 4 mm, then it is unsuitable for the posters displayed outdoors, restaurant menus, product signs at perishable foods stores, because the portions which are penetrated by water are transformed or transparentized.

Next, each layer formed on the image-receiving sheet for electrophotography of the present invention is described in detail.

### <Base Paper>

In the present invention, any one of high quality paper, medium quality paper, and low quality paper using wood pulp mainly can be used as the base paper. Further, paper including non-wood pulp, synthetic pulp, and synthetic fiber may be used.

There are no particular restrictions on the basis weight of the base paper, although a base paper with a basis weight of 50 to 250 g/m² can be used according to use. If the basis weight is less than 50 g/m², strength of the base paper is not sufficient, and if the basis weight exceeds 250 g/m², strength of the base paper is excessive, as a result, poor conveying problems easily occur during the printing in both cases. Further, the basis weight of less than 50 g/m² is not preferable for posters, cards and photographs or the like due to the strength being insufficient. The preferable range of the basis weight is 70 to 220 g/m², and the more preferable range of the basis weight is 100 to 200 g/m² for such as cards and color photographs. Further, the thickness of the base paper can be optionally adjusted based on the total thickness of the image-receiving sheet for electrophotography, although enlarging the thickness of the base paper relative to the total thickness is favorable to the material cost.

It is necessary for the base paper to have water-resistance, and it is preferable for the base paper to have section-water-resistance which is able to prevent penetration of the water from the section.

If the base paper lacks water-resistance, unevenness occurs around the edges due to the penetration of the water from the edges when used for such as outdoor posters and product signs at perishable food stores. In addition, when using oil or the like, the portions around the edges can be transparentized.

Examples of the methods to give the base paper water-resistance include internal sizing method of adding internal additives during the paper manufacturing, surface sizing method using a size press, combination of both methods, and method of impregnating (coating) resin to the raw paper after the paper manufacturing. In the present invention, taking the prevention of penetration from other liquids such as oil, impregnating (coating) resin to the raw paper after the paper manufacturing is preferable.

Examples of resins for impregnation (coating) include water-based resin, organic solvent-based resin and solvent-free resin, although the solvent-based resin and the solvent-free resin are preferable, because generally, the paper has been treated to be water-resistant to some extent, so the water-based resin is difficult to impregnate. Further, the solvent-based resin is preferable for adjusting the impregnation amount, because in the case of the solvent-based resin, the deposition amount of the resin can be easily adjusted by varying the density of the resin in the impregnation solution.

There are no particular restrictions on the resins for impregnation, although those having both water-resistance and oil-resistance are preferable. For example, phenolic resin, melamine resin, poly vinylidene chloride resin, polyvinyl chloride resin, polyester-based resin, polyamide-based resin, polyurethane-based resin, acryl-based resin, other thermosetting resins or thermoplastic resins, and synthetic resin latexes can be used.

The deposition amount of the resin with respect to the raw paper is preferably within a range of 1 to 20% by weight, more preferably within a range of 2 to 10% by weight, and even more preferably within a range of 2 to 7% by weight. If the deposition amount is less than 1% by weight, effects of giving the base paper water-resistance are poor. If the deposition amount exceeds 20% by weight, poor conveying problems occur during the printing due to the paper being too hard, and since the paper is transparentized, it is unsuitable for the base paper in some cases.

The impregnation solution can include other chemicals according to needs. In the present invention, for example, a low-resistance treatment agent is preferably included.

The moisture of the base paper used in the present invention is preferably not more than 5%, more preferably not more than 4.5%, even more preferably not more than 4%. If the moisture exceeds 5%, blistering occurs easily during the heat fixing. The measurement of the moisture is by JIS P 8127.

The base paper used in the present invention may be colored according to use. However, in the case of color photographs, if the base paper is colorized, the image appears obscure, and saturation is not sufficient, so it is not preferable. In order to make the color images appear brighter and more saturated, whitening the external appearance is preferable, and using fluorescence dyes by internally adding and coating at the stage of raw paper is preferable.

In the base paper used in the present invention, Bekk smoothness measured by JIS P 8119 is preferably not less than 20 seconds, and more preferably not less than 50 seconds. If Bekk smoothness less than 20 seconds, high quality appearance of the image is lost. Bekk smoothness of not less than 65 seconds is preferable for photographs. Bekk smoothness can be adjusted by machine calendar or super calendar.

### <Plastic Film>

Examples of the plastic films used in the present invention, include polyolefin films, such as polyethylene, polypropylene; polyester such as polyethylene terephthalate, polyethylene naphthalate, polyethylene isophthalate, polybutylene terephthalate; polyvinyl chloride, polystyrene, polymethyl methacrylate, polycarbonate, cellophane, cellulose acetate, polyarylate and polysulfone. In the present invention, from the viewpoints of thermal resistance that the films do not transform during the heat fixing, conveying during the printing, and water and oil resistances of the printing matter, the polyester film is preferable, and the polyethylene terephthalate (PET) film is more preferable.

The thickness of the film can be optionally adjusted based on the total thickness of the image-receiving sheet for electrophotography, although it is usually adjusted to within a range of 12 to 100 μm.

### <Toner-Receiving Layer>

Forming the toner-receiving layer is to improve the toner transfer property and fixing property so as to provide high quality images, and the toner-receiving layer includes resin with a glass transition temperature of 0 to 80° C. as the main component. Further, in the case of the image-receiving sheet for electrophotography of the first aspect, the toner-receiving layer includes a low-resistance treatment agent and/or inorganic fine particles according to needs. In the case of the image-receiving sheet for electrophotography of the second aspect, a low-resistance treatment agent and organic fine particles are included.

Examples of the resins forming the toner-receiving layer include polyolefin resins such as polyethylene, polypropylene; polyvinyl chloride, polyvinylidene chloride, polyvinyl acetate, vinyl chloride-vinyl acetate copolymer, polyacrylate, polyester-based resin, polyethylene terephthalate, polybutylene terephthalate, polystyrene-based resin, polyamide-based resin, copolymer in which olefin such as ethylene and propylene, and other vinyl monomer are polymerized; cellulose-based resins such as ionomer, ethyl cellulose, cellulose acetate, nitrocellulose; polycarbonate resin, and urethane resin. Among these, vinyl-based resin, polyester-based resin, vinyl chloride-vinyl acetate copolymer resin, polyamide-based resin and urethane resin are preferable, and polyester-based resin, polyamide-based resin and urethane resin are more preferable.

The glass transition temperature (Tg) of the resin is necessarily within a range of 0 to 80° C., more preferably within a range of 15 to 65° C., and even more preferably within a range of 30 to 50° C. If Tg is less than 0° C., the fixing property is inferior because the toner-receiving layer easily transforms when the toner-receiving layer is rubbed against others, and the fixed toner easily detaches. Further, multi-feeding occurs easily due to the blocking of the image-receiving sheets on which printing is not done yet. On the other hand, if Tg exceeds 80° C., it is difficult to be heat fixed because the toner-receiving layer tends to be hard. As a result, the fixing strength decreases, and fixing property is inferior. In order to adjust Tg of the resin, a plural number of resins with different Tg can be used jointly. In the present invention, Tg is the value of the middle point glass transition temperature measured by the method described in 9.3 of JIS K 7121-1987.

In the image-receiving sheet of the second aspect of the present invention, the toner-receiving layer includes a low-resistance treatment agent for adequacy of the surface resistance. Also, in the image-receiving sheet for electrophotograpy of the first aspect of the present invention, the low-resistance treatment agent is preferably included. For the low-resistance treatment agent, well-known cation-based, anion-based, zwitterion-based and nonion-based low-resistance treatment agents can be used. Examples of the cation-based low-resistance treatment agents include quaternary ammonium salt, polyamine derivative, and examples of the anion-based low-resistance treatment agents include alkyl phosphite, polystyrene sulfonate, and examples of the nonion low-resistance treatment agents include fatty acid ester. In the present invention, quaternary ammonium salt is preferably used.

It is necessary for the content of the low-resistance treatment agent in the toner-receiving layer to be adjusted to an appropriate range so that the surface resistance of the toner-receiving layer is within an appropriate range, although the content of the low-resistance treatment agent is preferably within a range of 0.01 to 40% by weight, more preferably within a range of 0.1 to 20% by weight, and even more preferably within a range of 1 to 10% by weight. If the content is less than 0.01% by weight, the effect of lowering the surface resistance of the toner-receiving layer is poor. If the content exceeds 40% by weight, the surface resistance tends to decrease too low.

In the image-receiving sheet for electrophotograpy of the second aspect of the present invention, the toner-receiving layer includes organic polymer fine particles in order to prevent multi-feeding caused by the blocking of the image-receiving sheets on which printing is not yet done when the paper is fed to the electrophotographic printing machines and printers, and to prevent the sticking of printed matter during continuous printing. Examples of the organic polymer fine particles include polyolefin fine particle such as acryl resin fine particle, polyethylene fine particle; polystyrene fine particle, and ethylene-acrylic acid copolymer fine particle. Especially, because the toner-receiving layer is heated during the toner-fixing, in order to prevent the printed matter in which the toner is fixed from sticking to each other, thermal-resistant acryl resin fine particles are preferable. The acryl resin fine particles can be obtained by polymerizing acrylic acid and derivative thereof. Examples of the acryl resins include polymers of monomers such as acrylic acid, acrylic ester, acryl amide, acrylonitrile, methacrylic acid and methacrylic ester, and a copolymer in which these monomers and other monomers such as styrene and vinyl acetate are polymerized. Among the acrylic resin fine particles, cross-linked polymethacrylic ester fine particles excellent in thermal resistance are preferable.

For the diameter of the organic polymer fine particles, in order to maintain the effects of preventing blocking and sticking, it is necessary for the fine particles to protrude from the surface, although if the diameter of the fine particles relative to the toner-receiving layer is too large, toner-fixing and visibility of the image become inferior, so the diameter of the fine particles can be adjusted based on the balance between the two. For the approximate standard of the diameter of the fine particles, it is preferably larger than the thickness of the toner-receiving layer by a range of not more than 5 μm, and generally, the average particle diameter of the organic polymer fine particles is preferably within a range of 0.5 to 15 μm.

The content of the organic polymer fine particles in the toner-receiving layer is preferably within a range of 1 to 20% by weight, more preferably within a range of 5 to 15% by weight. If the content is less than 1% by weight, then the multi-feeding occurs in the printing machines and printers, or sticking easily occurs during the consecutive printing, because the image-receiving sheets easily blocks. If the content exceeds 20% by weight, the organic polymer fine particles detach easily from the surface of the toner-receiving layer.

In the present invention, in order to improve the effects of preventing the multi-feeding caused by blocking of the image-receiving sheets, inorganic fine particles may be included in the toner-receiving layer. Examples of the inorganic fine particles include silica, clay, talc, kaolin, quartz, aluminium hydroxide, titania, aluminium sulfate, zinc oxide, calcium carbonate and glass beads. The average primary particle diameters of these inorganic fine particles are preferably within a range of 0.01 to 1 μm. Further, the content of the inorganic fine particles is preferably within a range of 0.1 to 10% by weight, more preferably within a range of 0.5 to 5% by weight. If the content is less than 0.1% by weight, improvement of the blocking is ineffective, and multi-feeding easily occurs in the printing machines and printers. If the content exceeds 10% by weight, the fine particles easily detach from the surface of the toner-receiving layer.

The surface resistance of the toner-receiving layer in the image-receiving sheet of the first aspect of the present invention, is necessarily within a range of 1×10⁷ to 1×10¹¹ Ω/□, and preferably within a range of 1×10⁸ to 1×10¹⁰ Ω/□. Further, the surface resistance of the toner-receiving layer in the image-receiving sheet of the second aspect is preferably within a range of 1×10⁷ to 1×10¹¹ Ω/□. If the surface resistance is less than 1×10⁷ Ω/□, then it is difficult to transfer, and image unevenness occurs easily. On the other hand, if the surface resistance exceeds 1×10¹¹ Ω/□, fogging may occur in the non-image parts.

The surface resistance is measured by JIS K 6911-1995 5.13.1, using KAWAGUCHI TERAOHM METER VE-30 manufactured by KAWAGUCHI co., Ltd. under the conditions of 23° C./65% RH.

In the image-receiving sheet for electro photography of the present invention, the toner-receiving layer may be formed on one or both surfaces according to use, although from the viewpoint of the balance between obverse and reverse, it is preferable that the same layer also be formed on the non-image surface. Further, in the case of forming the toner-receiving layers on both surfaces, the surface resistances of both surfaces are preferably within the range described above.

The deposition amount of the toner-receiving layer is preferably in a range of 0.01 to 10 g/m², more preferably in a range of 0.05 to 5 g/m². If the deposition amount is less than 0.01 g/m², the purpose of the forming toner-receiving layer can not be attained, and the deposition amount exceeding 10 g/m² is not preferable, because the effects of the toner-receiving layer can not be more improved, and the material cost increases, the productivity decreases. Further, the thickness of the toner-receiving layer is preferably within a range of 0.01 to 10 μm, more preferably within a range of 0.05 to 5 μm.

The method of forming toner-receiving layer is as follows.

A coating solution is prepared by dissolving and dispersing resin and other materials, for example, a low-resistance treatment agent, organic fine particles, inorganic fine particles to a solvent. A predetermined amount of the coating solution is coated by a well-known coating method. The well-known coating methods can be classified roughly into roll type, bar type, blade type and air knife type. For the roll type coating methods, size press, metering size press, consolidated coater, contra coater, gate roll coater, KCM coater, gravure coater, reverse roll coater can be used. For the bar type coating method, metering bar coater, comma bar coater can be used. The blade type coating methods can be classified into bevel blade type and vent blade type depending on the blade placed. Further, some examples of coating methods classified by the shape of the head include bond blade coater, flexi-blade coater, flooded-nip coater, fountain blade coater, champflex coater, bill blade coater. Screen type printing method can also be used for coating solution.

In the present invention, a gravure type coating method which is able to coat relatively low viscosity coating solution with a high precision and convenience is preferably used.

### <Adhesive Layer>

The adhesive layer includes at least an adhesive resin, and includes others such as low-resistance treatment agent according to needs.

For the adhesive resin used in the adhesive layer, if the resin just has adhesive property, there are no particular restrictions on the resin, and thermoplastic resin, thermosetting resin and rubber (elastomer)-based resin can be used.

The thermoplastic resin can be used in the form of solution, emulsion and latex. Examples of the resin components include polyvinyl acetate, polyvinyl alcohol, polyvinyl acetal, polyvinyl alkyl ether, cyanoacrylate, polyvinyl chloride, polyamide, polymethacrylic ester such as polymethyl methacrylate, polyacrylic ester such as polymethyl acrylate, nitrocellulose, cellulose acetate, polystyrene, ethylene-vinyl acetate copolymer, ethylene-acrylic ester copolymer, thermoplastic epoxy resin, copolymers of the monomers which are constituting the above polymers, and derivatives of the above polymers. In addition, plural kinds of the above resins may be mixed to use according to needs.

The thermosetting resins which generally are liquid at normal temperature, and are curing by heating or mixing 2 to 3 components such as catalyst, curing agent, and curing accelerator, can be used. Examples of the resins include melamine resin, urea resin, phenol resin, resorcinol resin, furan resin, epoxy resin, unsaturated polyester resin, polyurethane resin, polyimide resin, polyamide-imide resin, poly benzothiazole resin, polybenzimidazole resin, and also include adhesive such as two-component curing type using base resin and curing resin.

The rubber (elastomer)-based resins are elastic high molecular compounds including natural rubber or synthetic rubber as the main component. Examples of the rubber-based resins include natural rubber, regenerated rubber, styrene-butadiene rubber, acrylic-nitrile-butadiene rubber, chloroprene rubber, butyl rubber, and isoprene rubber.

In the present invention, for the resins used in the adhesive layer, the two-component curing type polyurethane resin is preferable.

In the present invention, in order to improve the toner transfer property, the adhesive forming the adhesive layer preferably includes the low-resistance treatment agent so as to keep a low surface resistance of the adhesive layer.

Examples of the low-resistance treatment agent can include agents described above, although quaternary ammonium salt is preferable. The content of the low-resistance treatment agent in the adhesive with respect to the solid content of the adhesive is preferably within a range of 0.1 to 15% by weight, more preferably within a range of 0.5 to 10% by weight. If the content is less than 0.1% by weight, effects of the lowering surface resistance are poor. If the content exceeds 15% by weight, it is not preferable due to the decrease of the adhesive strength.

Colorations such as coloring pigment, coloring dye, or fluorescent dye can be mixed in the adhesive layer according to needs.

In the present invention, the deposition amount of the adhesive described above is preferably within a range of 1 to 50 g/m², more preferably within a range of 5 to 20 g/m². If the deposition amount is less than 1 g/m², uniform adhering is impossible, and the adhesive strength is not sufficient. If the deposition amount exceeds 50 g/m², it results in increase of the cost because the deposition amount exceeds the weight required. Further, the thickness of the adhesive layer is preferably within a range of 1 to 50 μm, more preferably within a range of 5 to 20 μm.

The surface resistance of the adhesive layer is preferably within a range of 1×10⁸ to 1×10¹² Ω/□, more preferably within a range of 1×10⁹ to 1×10¹¹ Ω/□. If the surface resistance is less than 1×10⁸ Ω/□, then the transfer property tends to decrease due to the excessively low surface resistance; if the surface resistance exceeds 1×10¹² Ω/□, then fogging occurs easily in the non-image parts. The surface resistance measurement is the same as the measurement of the surface resistance of the toner-receiving layer described above.

### <Production of the Image-Receiving Sheet for Electrophotography>

The image-receiving sheet for electrophotography of the present invention, for example, as shown in FIG. 1 or FIG. 3, can be produced as follows.

(1) The toner-receiving layer is formed on one surface of the plastic film.

(2) The adhesive layer is formed on the other surface of the plastic film.

(3) One surface of the base paper is adhered to the above plastic film through the adhesive layer.

(4) The other surface of the base paper is adhered to the plastic film in which toner-receiving layer and adhesive layer are formed in the same manner as described in the above (1) and (2).

Generally, the following methods of (1) to (5) can be given as methods for adhering two substrates through an adhesive layer, and any one of the methods may be used for producing the image-receiving sheet for electrophotograpy of the present invention. However, the dry lamination method (1) is preferable for adhering the base paper and the plastic film.

(1) Dry Lamination

The adhesive is coated on one surface of the substrate so that the solvent is in a state of being almost volatilized, and the other substrate is laminated over the substrate to pressurize and/or heat.

(2) Wet Lamination

The adhesive is coated on one surface of the substrate, and the other substrate is laminated over the substrate to dry.

(3) Hot Melt Lamination

A hot melt adhesive in melted state is coated on one surface of the substrate, and the other substrate is laminated over the substrate immediately to cool.

(4) Heat Seal Lamination

The substrate in which the hot melt resin is coated on the one surface of the substrate beforehand is laminated on the other substrate to heat-pressurize. Or, a heat melt resin film is set between the two substrates to heat-pressurize.

(5) Extrusion Lamination

A film-shaped adhesive resin which is in melted state is pushed out from the T-die of an extruder to a space between the two substrates to heat-pressurize.

Among the above-described adhering methods, well-known coating methods which are the same as described in the method of formation of the toner-receiving layer can be optionally used for coating adhesives described in (1) to (3). Further, a coating method of a screen printing system can be used.

### EXAMPLES

Examples are given below to explain the present invention in detail, although the following examples are not limitative of the invention. The parts of blend quantity of the raw materials are in weight parts, and the ratios of the solid content percentages are in weight percentages.

### <Production of Base Paper>

### (Preparation of Impregnation Solution)

An acryl resin (manufactured by HUJIKURAKASEI Co., Ltd., product name: acryl-based LH 101, solution with a solid content of 40% by weight) was diluted with toluene to prepare the impregnation solution with a solid content of 15% by weight.

### (Production of Base Paper)

A high quality paper (manufactured by OJI PAPER Co., Ltd., product name: marshmallow) including fluorescence dye with a basis weight of 128 g/m² was used as a raw paper, and the base paper with a solid content of 5 g/m² was obtained by impregnating the impregnation solution described above. The thickness of the base paper was 150 μm, and Bekk smoothness of the base paper was 80 seconds. Base paper (A) with a moisture content of 4.0% and base paper (B) with a moisture content of 4.8% were produced by adjusting the moisture contents.

### <Formation of Toner-Receiving Layer>

### (Formation of Toner-Receiving Layer (a))

Coating solution 1 for the toner-receiving layers was prepared with the following composition.
Toluene: 24.3 parts
Methyl ethyl ketone: 16.4 parts
Hydrophobic silica: 0.07 parts (manufactured by NIPPON AEROSIL Co., Ltd., product name: R972, average primary particle diameter: 0.016 μm)
Low-resistance treatment agent (quaternary ammonium salt): 5.7 parts (manufactured by NIPPON KAKO TORYO Co., Ltd., product name: No. 1-30, solution adjusted by diluting a solution of 30% by weight to 10 times)
Polyester resin (A) (solution of 30% by weight): 5.0 parts (manufactured by TOYOBO Co., Ltd., product name: VYLON® GK130, Tg: 15° C.)
Polyester resin (B) (solution of 30% by weight): 10.0 parts (manufactured by TOYOBO Co., Ltd., product name: VYLON® 60SS, Tg: 47° C.)

Tg of the mixed resin obtained by mixing polyester resin (A) and polyester resin (B) at the above ratio was 36° C.

Coating solution 1 described above was coated on the transparent PET film (manufactured by UNITIKA Co., Ltd., product name: EMBLET®) with a thickness of 38 μm by a gravure printing method so that the deposition amount was 2 g/m², and dried to form toner-receiving layer (a) on the transparent PET film. The thickness of toner-receiving layer (a) was 2 μm, and the surface resistance of toner-receiving layer (a) was 3.0×10⁹ Ω/□. For the ratios of the solid contents of toner-receiving layer (a), the hydrophobic silica was 1.5%, the low-resistance treatment agent was 3.6%, and the polyester resin was 94.9%.

### (Formation of Toner-Receiving Layer (b))

With the exception of using only 15.0 parts of polyester (B) as the resin in the coating solution 1, toner-receiving layer (b) was formed on the transparent PET film in the same manner as toner-receiving layer (a). The thickness of toner-receiving layer (b) was 2 μm, and the surface resistance of toner-receiving layer (b) was 3.0×10⁹ Ω/□. The ratios of the solid contents of toner-receiving layer (b) were the same as toner-receiving layer (a).

### (Formation of Toner-Receiving Layer (c))

With the exception of using only 15.0 parts of polyester resin (C) (solution of 30% by weight) (manufactured by TOYOBO Co., Ltd., product name: VYLON® 290, Tg: 72° C.) as the resin in coating solution 1, toner-receiving layer (c) was formed on the transparent PET film in the same manner as toner-receiving layer (a). The thickness of toner-receiving layer (c) was 2 μm, and the surface resistance of toner-receiving layer (c) was 3.0×10⁹ Ω/□. The ratios of the solid contents of toner-receiving layer (c) were the same as toner-receiving layer (a).

### (Formation of Toner-Receiving Layer (d))

With the exception of using 11 parts of the low-resistance treatment agent in coating solution 1, toner-receiving layer (d) was formed on the transparent PET film in the same manner as toner-receiving layer (a). The thickness of toner-receiving layer (d) was 2 μm, and the surface resistance of toner-receiving layer (d) was 1.0×10⁸ Ω/□. For the ratios of the solid contents of toner-receiving layer (d), the hydrophobic silica was 1.4%, the low-resistance treatment agent was 6.7%, and the polyester resin was 91.9%.

### (Formation of Toner-Receiving Layer (e))

With the exception of using 4.0 parts of the low-resistance treatment agent in coating solution 1, toner-receiving layer (e) was formed on the transparent PET film in the same manner as toner-receiving layer (a). The thickness of toner-receiving layer (e) was 2 μm, and the surface resistance of the formed toner-receiving layer (e) was 9.5×10⁹ Ω/□. For the ratios of the solid contents of toner-receiving layer (d), the hydrophobic silica was 1.5%, the low-resistance treatment agent was 2.6%, and the polyester resin was 95.9%.

### (Formation of Toner-Receiving Layer (f))

With the exception of using only 15.0 parts of polyester resin (D) (solution of 30% by weight) (manufactured by TOYOBO Co., Ltd., product name: VYLON® GM900, Tg: −15° C.) as the resin in coating solution 1, toner-receiving layer (f) was formed on the transparent PET film in the same manner as toner-receiving layer (a). The thickness of toner-receiving layer (f) was 2 μm, and the surface resistance of toner-receiving layer (f) was 3.0×10⁹ Ω/□. The ratios of the solid contents of toner-receiving layer (f) were the same as toner-receiving layer (a).

### (Formation of Toner-Receiving Layer (g))

With the exception of using only 15.0 parts of polyester resin (E) (solution of 30% by weight) (manufactured by TOYOBO Co., Ltd., product name: VYLON® GK880, Tg: 84° C.) as the resin in coating solution 1, toner-receiving layer (g) was formed on the transparent PET film in the same manner as toner-receiving layer (a). The thickness of toner-receiving layer (g) was 2 μm, and the surface resistance of toner-receiving layer (g) was 3.0×10¹⁰ Ω/□. The ratios of the solid contents of toner-receiving layer (g) were the same as toner-receiving layer (a).

### (Formation of Toner-Receiving Layer (h))

With the exception of using 18 parts of the low-resistance treatment agent in coating solution 1, toner-receiving layer (h) was formed on the transparent PET film in the same manner as toner-receiving layer (a). The thickness of toner-receiving layer (h) was 2 μm, and the surface resistance of toner-receiving layer was 6.5×10⁶ Ω/□. For the ratios of the solid contents of toner-receiving layer (h), the hydrophobic silica was 1.4%, the low-resistance treatment agent was 10.6%, and the polyester resin was 88%.

### (Formation of Toner-Receiving Layer (i))

With the exception of using 1.5 parts of the low-resistance treatment agent in coating solution 1, toner-receiving layer (i) was formed on the transparent PET film in the same manner as toner-receiving layer (a). The thickness of toner-receiving layer (i) was 2 μm, and the surface resistance of toner-receiving layer (i) was 4.0×10¹² Ω/□. For the ratios of the solid contents of toner-receiving layer (i), the hydrophobic silica was 1.5%, the low-resistance treatment agent was 1.0%, and the polyester resin was 97.5%.

### (Formation of Toner-Receiving Layer (j))

Coating solution 2 for the toner-receiving layers was prepared with the following composition.
Toluene: 24.3 parts
Methyl ethyl ketone: 16.4 parts
Organic polymer fine particles (A): 0.52 parts (manufactured by GANZ CHEMICAL Co., Ltd, product name: GM-0407S, cross-linking polymethyl methacrylate fine particles, average particle diameter: 4 μm)
Low-resistance treatment agent (quaternary ammonium salt): 6.3 parts (manufactured by NIPPON KAKO TORYO Co., Ltd., product name: No. 1-30, solution adjusted by diluting a solution of 30% by weight to 10 times)
Polyester resin (A): 5.0 parts (manufactured by TOYOBO Co., Ltd., product name: VYLON® GK130, 30% by weight, Tg: 15° C.)
Polyester resin (B): 10.0 parts (manufactured by NIPPON KAKO TORYO Co., Ltd., product name: VYLON® 60SS, 30% by weight, Tg: 47° C.)

Tg of the mixed resin obtained by mixing polyester resin (A) and polyester resin (B) at the above ratio was 36° C.

Coating solution 2 describe above was coated on the transparent PET film (manufactured by UNITIKA Co., Ltd., product name: emblect) with a thickness of 38 μm by a gravure printing method so that the deposition amount was 2 g/m² and dried to form toner-receiving layer (j) on the transparent PET film. The thickness of the formed toner-receiving layer (j) was 2 μm, and the surface resistance of the formed toner-receiving layer (j) was 3.0×10⁹ Ω/□. For the ratios of the solid contents of toner-receiving layer (a), the organic polymer fine particle was 10.0%, the low-resistance treatment agent was 3.6%, and the polyester resin was 86.4%.

### (Formation of Toner-Receiving Layer (k))

With the exception that the blend quantity of the organic polymer fine particles (A) was 0.10 parts and the blend quantity of the low-resistance treatment agent was 5.7 parts in coating solution 2, toner-receiving layer (k) was formed on the transparent PET film in the same manner as toner-receiving layer (j). The thickness of the formed toner-receiving layer (k) was 2 μm, and the surface resistance of the formed toner-receiving layer (k) was 3.0×10⁹ Ω/□. For the ratios of the solid contents of toner-receiving layer (k), the organic polymer fine particle was 2.0%, the low-resistance treatment agent was 3.6%, and the polyester resin was 94.4%.

### (Formation of Toner-Receiving Layer (l))

With the exception that the blend quantity of the organic polymer fine particle (A) was 1.18 parts and the blend quantity of the low-resistance treatment agent was 7.1 parts in coating solution 2, toner-receiving layer (l) was formed on the transparent PET film in the same manner as toner-receiving layer (j). The thickness of the formed toner-receiving layer (l) was 2 μm, and the surface resistance of the formed toner-receiving layer (l) was 3.0×10⁹ Ω/□. For the ratios of the solid contents of toner-receiving layer (l), the organic polymer fine particle was 20.0%, the low-resistance treatment agent was 3.6%, and the polyester resin was 76.4%.

### (Formation of Toner-Receiving Layer (m))

With the exception of replacing organic polymer fine particles (A) with organic polymer fine particles (B) (manufactured by GANZ CHEMICAL Co., Ltd., product name: GM-0630H, cross-linked polymethyl methacrylate fine particles, average particle diameter: 6 μm) in coating solution 2, toner-receiving layer (m) was formed on the transparent PET film in the same manner as toner-receiving layer (j). The thickness of the formed toner-receiving layer (m) was 2 μm, and the surface resistance of the formed toner-receiving layer (m) was 3.0×10⁹ Ω/□. The ratios of the solid contents of toner-receiving layer (m) were the same as the toner-receiving layer (j).

### (Formation of Toner-Receiving Layer (n))

With the exception of replacing organic polymer fine particles (A) with organic polymer fine particles (C) (manufactured by GANZ CHEMICAL Co., Ltd., product name: GM-1007S, cross-linked polymethyl methacrylate fine particles, average particle diameter: 10 μm) in coating solution 2, toner-receiving layer (n) was formed on the transparent PET film in the same manner as toner-receiving layer (j). The thickness of the formed toner-receiving layer (n) was 2 μm, and the surface resistance of the formed toner-receiving layer (n) was 3.0×10⁹ Ω/□. The ratios of the solid contents of toner-receiving layer (n) were the same as the toner-receiving layer (j).

### (Formation of Toner-Receiving Layer (o))

With the exception of replacing organic polymer fine particles (A) with organic polymer fine particles (D) (manufactured by GANZ CHEMICAL Co., Ltd., product name: GB-05S, cross-linked polybuthyl methacrylate fine particles, average particle diameter: 5 μm) in coating solution 2, toner-receiving layer (o) was formed on the transparent PET film in the same manner as toner-receiving layer (j). The thickness of the formed toner-receiving layer (o) was 2 μm, and the surface resistance of the formed toner-receiving layer (o) was 3.0×10⁹ Ω/□. The ratios of the solid contents of toner-receiving layer (o) were the same as the toner-receiving layer (j).

### (Formation of Toner-Receiving Layer (p))

With the exception of replacing organic polymer fine particles (A) with organic polymer fine particles (E) (manufactured by GANZ CHEMICAL Co., Ltd., product name: GS-0605S, cross-linked polystyrene fine particles, average particle diameter: 6 μm) in coating solution 2, toner-receiving layer (p) was formed on the transparent PET film in the same manner as toner-receiving layer (j). The thickness of the formed toner-receiving layer (p) was 2 μm, and the surface resistance of the formed toner-receiving layer (p) was 3.0×10⁹ Ω/□. The ratios of the solid contents of toner-receiving layer (p) were the same as the toner-receiving layer (j).

### (Formation of Toner-Receiving Layer (q))

With the exception of replacing a mixed resin which was mixture of polyester resin (A) and polyester resin (B) with 15.0 parts of polyester resin (B) only in coating solution 2, toner-receiving layer (q) was formed on the transparent PET film in the same manner as toner-receiving layer (j). The thickness of the formed toner-receiving layer (q) was 2 μm, and the surface resistance of the formed toner-receiving layer (q) was 3.0×10⁹ Ω/□. The ratios of the solid contents of toner-receiving layer (q) were the same as the toner-receiving layer (j).

### (Formation of Toner-Receiving Layer (r))

With the exception of replacing the mixed resin which was mixture of polyester resin (A) and polyester resin (B) with 15.0 parts of polyester resin (C) (manufactured by TOYOBO Co., Ltd., product name: VYLON® 290, solution of 30% by weight, Tg: 72° C.) in coating solution 2, toner-receiving layer (r) was formed on the transparent PET film in the same manner as toner-receiving layer (j). The thickness of the formed toner-receiving layer (r) was 2 μm, and the surface resistance of the formed toner-receiving layer (r) was 3.0×10⁹ Ω/□. The ratios of the solid contents of toner-receiving layer (r) were the same as the toner-receiving layer (j).

### (Formation of Toner-Receiving Layer (s))

With the exception of replacing the mixed resin which was mixture of polyester resin (A) and polyester resin (B) with 15.0 parts of polyester resin (D) (manufactured by TOYOBO Co., Ltd., product name: VYLON® GM900, solution of 30% by weight, Tg: −15° C.) in coating solution 2, toner-receiving layer (s) was formed on the transparent PET film in the same manner as toner-receiving layer (j). The thickness of the formed toner-receiving layer (s) was 2 μm, and the surface resistance of the formed toner-receiving layer (s) was 3.0×10⁹ Ω/□. The ratios of the solid contents of toner-receiving layer (s) were the same as the toner-receiving layer (j).

### (Formation of Toner-Receiving Layer (t))

With the exception of replacing the mixed resin which was mixture of polyester resin (A) and polyester resin (B) with 15.0 parts of polyester resin (E) (manufactured by TOYOBO Co., Ltd., product name: VYLON® GK880, solution of 30% by weight, Tg: 84° C.) in coating solution 2, toner-receiving layer (t) was formed on the transparent PET film in the same manner as toner-receiving layer (j). The thickness of the formed toner-receiving layer (t) was 2 μm, and the surface resistance of the formed toner-receiving layer (t) was 3.0×10⁹ Ω/□. The ratios of the solid contents of toner-receiving layer (t) were the same as the toner-receiving layer (j).

### (Formation of Toner-Receiving Layer (u))

With the exception that the blend quantity of organic polymer fine particles (A) was 0.50 parts and the blend quantity of the low-resistance treatment agent was 0 part in coating solution 2, toner-receiving layer (u) was formed on the transparent PET film in the same manner as toner-receiving layer (j). The thickness of the formed toner-receiving layer (u) was 2 μm, and the surface resistance of the formed toner-receiving layer (u) was 1.0×10¹⁵ Ω/□. For the ratios of the solid contents of toner-receiving layer (u), the organic polymer fine particle was 10.0%, and the polyester resin was 90.0%.

### <Preparation of Adhesive>

The adhesive was prepared by the following composition.

The polyurethane resin (manufactured by TAKEDA PHARMACEUTICAL Co., Ltd., product name: TAKELAC® A-367H, solid content: 35% by weight) and the curing agent (manufactured by TAKEDA PHARMACEUTICAL Co., Ltd., product name: TAKENATE® A-7, solid content: 80% by weight) were mixed at a ratio of solid content of 2:1, and the low-resistance treatment agent was added so as that the solid content of the low-resistance treatment agent was 4.8% by weight relative to the total weight, and then it was diluted to 30% by weight using ethyl acetate to prepare the adhesive.

### (Production of Image-Receiving Sheet for Electrophotography)

### EXAMPLE 1

The adhesive described above was coated on the uncoated surface of the transparent PET film in which toner-receiving layer (a) was formed by gravure printing method, so that the solid content was 10 g/m². The thickness of the adhesive layer was 9 μm, and the surface resistance of the adhesive layer was 5×10¹⁰ Ω/□. The adhesive layer of the PET film was adhered to the both surfaces of base paper (A) one side by one side by a dry lamination method to obtain the image-receiving sheet for electrophotography.

### EXAMPLES 2 TO 6, COMPARATIVE EXAMPLES 1 TO 4

The transparent PET films in which toner-receiving layers (b) to (i) were formed respectively were adhered to base paper (A) or (B) with the combinations shown in Table 1 in the same manner as described in Example 1.

### (Evaluation of Characteristics)

The image-receiving sheets for electrophotograpy obtained from the Examples and Comparative Examples were cut into A4 size to carry out color printing using the color copy machine (manufactured by RICOH Co., Ltd., product name : IPSIO CX7200). Various characteristics of the printed matter were evaluated. Methods of the evaluations are as follows.
(1) Water-resistance: water-resistance was evaluated using the impregnation degree of water from the edge surfaces. The measurement was carried out as follows. The image-receiving sheets for electrophotograpy were cut into a size of 4 cm×4 cm, and soaked in a red liquid ink (manufactured by PILOT Co., product name: PILOT® ink/red ink was diluted to 100 times with water) for 1 hour to measure the degrees of coloration from the edge surfaces. The maximum degree (mm) was determined as the impregnation degree of water from the edge surface.
(2) Fixing property: toner-adhered portions of the color printed samples were scraped at speed of 10 mm/second using a pin which was loaded with a load weight of 100 g, and then the scraped degree was measured by human observation.

A: not scraped off.

B: scraped off, but no problem in practical use.

C: scraped off.
(3) Transfer property: density evenness of the toner-adhered portions of the color printed samples were measured by human observation.

A: transferred uniformly and no density evenness was observed.

B: density evenness was observed, but no problem in practical use.

C: density evenness was terrible, and non-transfer was observed or fogging occurred in the non-image parts.
(4) Blister: foaming between the base paper and the transparent PET film in the image-receiving sheet discharged from the color copier was measured by human observation.

A: foam was observed.

B: fine foam was observed, but no problem in practical use.

C: large foam was observed and the film was completely separated from the base paper.

These evaluation results are shown in Table 1.

TABLE 1

| | | Toner-receiving layer | | | Water-resistance | | | |
|---|---|---|---|---|---|---|---|---|
| | Base paper | | Tg of resin | Surface resistance | (impregnation degree of | Fixing | Transfer | |
| | (moisture %) | Type | (° C.) | (Ω/□) | water from edge) | property | property | Blister |
| Ex. 1 | A (4%) | a | 36 | 3.0 × 10⁹ | 1 mm | A | A | A |
| Ex. 2 | A (4%) | b | 15 | 3.0 × 10⁹ | 1 mm | B | A | A |
| Ex. 3 | A (4%) | c | 72 | 3.0 × 10⁹ | 1 mm | B | A | A |
| Ex. 4 | A (4%) | d | 36 | 1.0 × 10⁸ | 1 mm | A | A | A |
| Ex. 5 | A (4%) | e | 36 | 9.5 × 10¹⁰ | 1 mm | A | B | A |
| Ex. 6 | B (4.8%) | a | 36 | 3.0 × 10⁹ | 1 mm | A | A | B |
| Comp. Ex. 1 | A (4%) | f | −15 | 3.0 × 10¹⁰ | 1 mm | C | A | A |
| Comp. Ex. 2 | A (4%) | g | 84 | 3.0 × 10¹⁰ | 1 mm | C | A | A |
| Comp. Ex. 3 | A (4%) | h | 36 | 6.5 × 10⁶ | 1 mm | A | C | A |
| Comp. Ex. 4 | A (4%) | i | 36 | 4.0 × 10¹² | 1 mm | A | C | A |

From the results shown in Table 1, it is clear that the image-receiving sheets for electrophotograpy of the present invention obtained from Examples 1 to 6 are excellent in water-resistance, toner-fixing property and transfer property without causing blisters or with causing blisters but no practical problems.

The image-receiving sheet for electrophotography obtained from Comparative Example 1 was inferior in fixing property because Tg of the resin used in the toner-receiving layer was too low.

The image-receiving sheet for electrophotography obtained from Comparative Example 2 was inferior in fixing property because Tg of the resin used in the toner-receiving layer was too high.

The image-receiving sheet for electrophotography obtained from Comparative Example 3 was inferior in transfer property because the surface resistance of the toner-receiving layer was too low.

In the image-receiving sheet for electrophotography obtained from Comparative Example 4, fogging occurred and transfer property was inferior because the surface resistance of the toner-receiving layer was high.

### EXAMPLE 7

The adhesive was coated on the uncoated surface of the transparent PET film in which toner-receiving layer (j) was formed by a gravure printing method so that the solid content was 10 g/m². The thickness of the adhesive layer was 9 μm, the surface of the adhesive layer was 5×10¹⁰ Ω/□. The adhesive layer of the transparent PET film was adhered to both surfaces of base paper (A) one side by one side by a lamination method to obtain the image-receiving sheet for electrophotography.

### EXAMPLES 8 TO 15, COMPARATIVE EXAMPLES 5 TO 7

The image-receiving sheets for electrophotography of Examples 8 to 15 and Comparative Examples 5 to 7 were obtained by using the transparent PET films in which toner-receiving layers (k) to (u) were formed respectively in the same manner as described in Example 7.

For the toner-receiving layers used for producing the image-receiving sheets for electrophotography of Examples 7 to 15 and Comparative Examples 5 to 7, Tg of resin, types of such as organic polymer fine particle, average particle diameter, ratio of particle content in the total solid content, content of low-resistance treatment agent are shown in Table 2.

TABLE 2

| | Base | | | | | | | |
|---|---|---|---|---|---|---|---|---|
| | paper | Toner- | Tg of resin in | Surface resistance of | Organic polymer fine particle | | | Content of |
| | (moisture | receiving | toner-receiving | toner-receiving layer | | Average particle | Content | low-resistance |
| | %) | layer | layer (° C.) | (Ω/□) | Type | diameter (μm) | (%) | treatment agent (%) |
| Ex. 7 | A (4%) | j | 36 | 3.0 × 10⁹ | Cross-linked | 4 | 10 | 3.6 |
| | | | | | polymethyl methacrylate | | | |
| Ex. 8 | A (4%) | k | 36 | 3.0 × 10⁹ | Cross-linked | 4 | 1.5 | 3.6 |
| | | | | | polymethyl methacrylate | | | |
| Ex. 9 | A (4%) | l | 36 | 3.0 × 10⁹ | Cross-linked | 4 | 20 | 3.6 |
| | | | | | polymethyl methacrylate | | | |
| Ex. 10 | A (4%) | m | 36 | 3.0 × 10⁹ | Cross-linked | 6 | 10 | 3.6 |
| | | | | | polymethyl methacrylate | | | |
| Ex. 11 | A (4%) | n | 36 | 3.0 × 10⁹ | Cross-linked | 10 | 10 | 3.6 |
| | | | | | polymethyl methacrylate | | | |
| Ex. 12 | A (4%) | o | 36 | 3.0 × 10⁹ | Cross-linked | 5 | 10 | 3.6 |
| | | | | | polymethyl methacrylate | | | |
| Ex. 13 | A (4%) | p | 36 | 3.0 × 10⁹ | Cross-linked | 6 | 10 | 3.6 |
| | | | | | polystyrene | | | |
| Ex. 14 | A (4%) | q | 15 | 3.0 × 10⁹ | Cross-linked | 4 | 10 | 3.6 |
| | | | | | Polymethyl methacrylate | | | |
| Ex. 15 | A (4%) | r | 72 | 3.0 × 10⁹ | Cross-linked | 4 | 10 | 3.6 |
| | | | | | Polymethyl methacrylate | | | |
| Comp. | A (4%) | s | −15 | 3.0 × 10⁹ | Cross-linked | 4 | 10 | 3.6 |
| Ex. 5 | | | | | Polymethyl methacrylate | | | |
| Comp. | A (4%) | t | 84 | 3.0 × 10⁹ | Cross-linked | 4 | 10 | 3.6 |
| Ex. 6 | | | | | Polymethyl methacrylate | | | |
| Comp. | A (4%) | u | 36 | 1.0 × 10¹⁵ | Cross-linked | 4 | 10 | 0 |
| Ex. 7 | | | | or more | Polymethyl methacrylate | | | |

### <Evaluation of the Characteristic>

The image-receiving sheets for electrophotography obtained from Examples 7 to 15 and Comparative Examples 5 to 7 were cut into A4 size to carry out color printing using the color copier (manufactured by RICHO Co., Ltd., product name: IPSIO CX7200). The various characteristics of the printed matter was evaluated. The results of the evaluation are shown in Table 3.

The evaluation methods of the water-resistance, fixing property and transfer property were the same as described above, and the evaluation method of sticking was as follows.
(5) Sticking

The laminated image-receiving sheets discharged from the color copier continuously were peeled, and sticking on the printed surface and the reverse surface was judged by human observation.

A: no sticking was observed.

B: sticking was observed slightly, but no problem in practical use.

C: toner was transferred to the reverse surface of the image-receiving sheet.

TABLE 3

| | Water-resistance | | | | |
|---|---|---|---|---|---|
| | (impregnation | | | | |
| | degree | Fixing | Transfer | | |
| | of water from edge) | property | property | Blister | Sticking |
| Ex. 7 | 1 mm | A | A | A | A |
| Ex. 8 | 1 mm | A | A | A | B |
| Ex. 9 | 1 mm | A | B | A | A |
| Ex. 10 | 1 mm | A | A | A | A |
| Ex. 11 | 1 mm | A | B | A | A |
| Ex. 12 | 1 mm | A | A | A | A |
| Ex. 13 | 1 mm | A | A | A | A |
| Ex. 14 | 1 mm | B | A | A | A |
| Ex. 15 | 1 mm | B | A | A | A |
| Comp. Ex. 5 | 1 mm | C | A | A | A |
| Comp. Ex. 6 | 1 mm | C | A | A | A |
| Comp. Ex. 7 | 1 mm | A | C | A | A |

From the results shown in Table 3, it is clear that the image-receiving sheets for electrophotography obtained from Examples 7 to 15 were excellent in the water-resistance, toner-fixing property and transfer property without forming blisters, and without causing sticking or with causing sticking but no problem in practice use.

The image-receiving sheets for electrophotography obtained from Comparative Examples 5 and 6 were inferior in fixing property because Tg of the resin used in each toner-receiving layer were too low, or too high.

The image-receiving sheet obtained from Comparative Example 7 was inferior in the transfer property and fogging occurred because the low-resistance treatment agent was not used.

### INDUSTRIAL APPLICABILITY

The water-resistant image-receiving sheet for electrophotography of the present invention is suitable for posters, cards, labels and color photographs, because the image-receiving sheet is excellent in water-resistance, anti-fouling property, fixing property and transfer property, and can provide high quality color images without forming blisters during the heat fixing, and/or without causing sticking during the consecutive printing.

1. A water-resistant image-receiving sheet for electrophotography, comprising:
a base paper,
one or two plastic films adhered onto one or both surfaces of the base paper, and
a toner-receiving layer formed over at least one of the plastic films, wherein
a main component of the toner-receiving layer is resin with a glass transition temperature of 0 to 80° C., and
surface resistance of the toner-receiving layer is 1×10⁷ to 1×10¹¹ Ω/□.

2. A water-resistant image-receiving sheet for electrophotography, comprising:
a base paper,
one or two plastic films adhered onto one or both surfaces of the base paper, and
a toner-receiving layer formed over at least one of the plastic films, wherein
the toner-receiving layer includes resin with a transition temperature of 0 to 80° C., a low-resistance treatment agent and organic polymer fine particles.

3. The water-resistant image-receiving sheet for electrophotography according to claim 2, wherein
the organic polymer fine particles are acryl resin particles with an average particle diameter of 0.5 to 15 μm.

4. The water-resistant image-receiving sheet for electrophotography according to claim 2, wherein
surface resistance of the toner-receiving layer is 1×10⁷ to 1×10¹¹ Ω/□.

5. The water-resistant image-receiving sheet for electrophotography according to claim 1 or 2, wherein
moisture of the base paper is not more than 5%.

6. The water-resistant image-receiving sheet for electrophotography according to claim 1 or 2, wherein
the base paper is resin-impregnated.

7. The water-resistant image-receiving sheet for electrophotography according to claim 1 or 2, wherein
the plastic films are adhered through adhesive layers.

8. The water-resistant image-receiving sheet for electrophotography according to claim 1 or 2, wherein
the plastic films are polyethylene terephthalate films.

9. The water-resistant image-receiving sheet for electrophotography according to claim 1 or 2, wherein
impregnation degree of water from an edge surface is not more than 4 mm.
